(19) United States
(12) Patent Application Publication
(10) Pub. No.: US 2012/0014605 A1
(43) Pub. Date: Jan. 19, 2012

(54) IMAGE PROCESSING APPARATUS, IMAGE PROCESSING METHOD, AND COMPUTER-READABLE RECORDING MEDIUM

(75) Inventor: Manabu Yamazoe, Tokyo (JP)

(73) Assignee: CANON KABUSHIKI KAISHA, Tokyo (JP)

(21) Appl. No.: 13/167,849

(22) Filed: Jun. 24, 2011

(30) Foreign Application Priority Data
Jul. 16, 2010 (JP) 2010-162294

(51) Int. Cl. G06K 9/46

(52) U.S. Cl. 382/190

(57) ABSTRACT

In region division of an image by a plurality of feature points, there is such a problem that a triangle with an extremely large distortion appears depending on arrangement of feature points when performing triangulation so that each region does not overlap one another. By the present invention, the frequency of occurrence of the triangle with a large distortion is reduced by analyzing a shape of each triangular region in particular and adding a feature point in the neighborhood of a triangular region having a distortion equal to or greater than a predetermined level.

### BACKGROUND OF THE INVENTION

1. Field of the Invention

The present invention relates to an image processing apparatus, an image processing method, and a program for determining a motion vector between a plurality of images.

2. Description of the Related Art

Conventionally, there have been disclosed techniques that calculate motion vectors between a plurality of frames to perform alignment between the frames.

A reference image refers to an arbitrary image frame in a motion picture frame. When calculating a motion vector of the reference image, a feature point that characterizes the image is used. Specifically, the calculation of a motion vector of the reference image is performed by calculating a difference between a feature point of the reference image and a certain region in a comparison image corresponding to the feature point. Japanese Patent Publication No. 3935500 discloses a method of dividing an image into triangular regions comprised of feature points when performing alignment between the frames by the motion vector of each feature point arranged irregularly. That is, by dividing an image into triangles having feature points at the vertexes, it is possible to estimate (interpolate) the motion vector of the pixel or region inside the triangle by the motion vectors of the feature points forming the triangle.

Because of this, even when the feature points are arranged irregularly, it is made possible to calculate a motion vector with a certain kind of regularity.

However, the technique described in the above-mentioned Japanese Patent Publication No. 3935500 has such a problem that a triangle with an extremely large distortion appears depending on the arrangement of feature points. When interpolating a motion vector by a triangle with a large distortion, the following problems occur.

That is, because the distances between feature points constituting a divided region increase and the motion vector of a pixel and the like inside the region is estimated (interpolated) by the motion vector of the far distant feature point, there may be a case where the interpolation precision is reduced. In addition to the above, when the distortion itself of the region becomes too large, there is a possibility that the internal interpolation precision itself cannot be maintained any more.

### SUMMARY OF THE INVENTION

According to the present invention, the precision of a motion vector determined for a pixel included in an image is improved by appropriately performing region division of the image.

An image processing apparatus according to the present invention comprises an obtaining unit configured to obtain a plurality of images, an extraction unit configured to extract a feature point of the image by analyzing any of the plurality of images obtained by the obtaining unit, an update unit configured to update the feature point of the image by adding or deleting a feature point to or from the image based on the position in the image of the feature point extracted by the extraction unit, and a deciding unit configured to decide a motion vector of a pixel included in the image with respect to another image included in the plurality of the images based on the feature point updated by the update unit.

According to the present invention, it is possible to improve the precision of a motion vector of a pixel included in an image by appropriately performing region division of the image.

Further features of the present invention will become apparent from the following description of exemplary embodiments (with reference to the attached drawings).

### BRIEF DESCRIPTION OF THE DRAWINGS

FIG. 1 is a diagram showing an example of a block configuration of an image processing apparatus according to an embodiment;

FIG. 2 is a conceptual diagram showing an outline of a method of creating a frame multiplex image;

FIG. 3 is a diagram showing a flowchart of image processing according to an embodiment;

FIG. 4 is a diagram showing an example in which an image is divided into triangular regions by feature points including added feature points to the image;

FIG. 5 is a diagram showing how to find a motion vector of a target pixel by area interpolation of a triangle;

FIG. 6 is a diagram showing a flowchart of image processing;

FIG. 7 is a diagram showing an example in which an image is divided into triangular regions by feature points;

FIG. 8 is a diagram showing an example in which the image is divided into triangular regions by an added feature point to the image;

FIG. 9 is a diagram showing an example of a triangular region with a large distortion and a motion vector of each feature point;

FIG. 10 is a diagram showing an example of a feature point added to a triangular region with a large distortion;

FIG. 11 is a diagram showing an example of division of a region including a triangular region with a large distortion; and

FIG. 12 is a diagram showing an example of division of a region in which a triangular region with a large distortion is eliminated.

### DESCRIPTION OF THE EMBODIMENTS

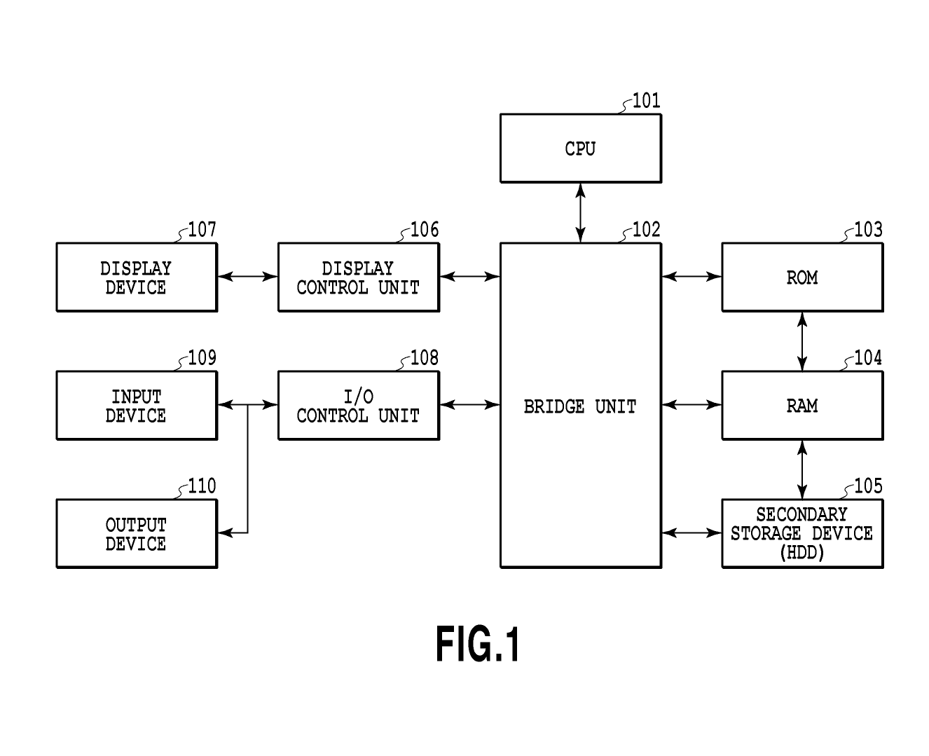

FIG. 1 shows a block diagram of an image processing apparatus according to an embodiment. Explanation is given on the assumption that a PC (Personal Computer) is used as an image processing apparatus.

A CPU (Central Processing Unit) 101 controls other functional blocks or apparatuses. A bridge unit 102 provides a function to control transmission/reception of data between the CPU 101 and the other functional blocks.

A ROM (Read Only Memory) 103 is a nonvolatile memory and stores a program called a BIOS (Basic Input/Output System). The BIOS is a program executed first when an image processing apparatus is activated and controls a basic input/output function of peripheral devices, such as a secondary storage device 105, a display device 107, an input device 109, and an output device 110.

A RAM (Random Access Memory) 104 provides a storage region where fast read and write are enabled. The secondary storage device 105 is an HDD (Hard Disk Drive) that provides a large-capacity storage region. When the BIOS is executed, an OS (Operating System) stored in the HDD is executed. The OS provides basic functions that can be used by all applications, management of the applications, and a basic GUI (Graphical User Interface). It is possible for an application to provide a UI that realizes a function unique to the application by combining GUIs provided by the OS.

The OS and data used in an execution program or working of another application are stored in the RAM 104 or the secondary storage device 105 according to the necessity.

A display control unit 106 generates image data of the GUI of the result of the operation by a user performed for the OS or application and controls the display on the display device 107. As the display device 107, a liquid crystal display or CRT (Cathode Ray Tube) display can be used.

An I/O control unit 108 provides an interface between a plurality of the input devices 109 and the output devices 110. As a representative interface, there are a USB (Universal Serial Bus) and PS/2 (Personal System/2).

The input device 109 includes a keyboard and mouse with which a user enters his/her intention to the image processing apparatus. Further, by connecting a digital camera or a storage device such as a USB memory, a CF (Compact Flash) memory and an SD (Secure Digital) memory card and the like to the input device 109, it is also possible to transfer image data.

It is possible to obtain a desired print result by connecting a printer as the output device 110. The application that realizes image processing according to an embodiment is stored in the secondary storage device 105 and provided as an application to be activated by the operation of a user.

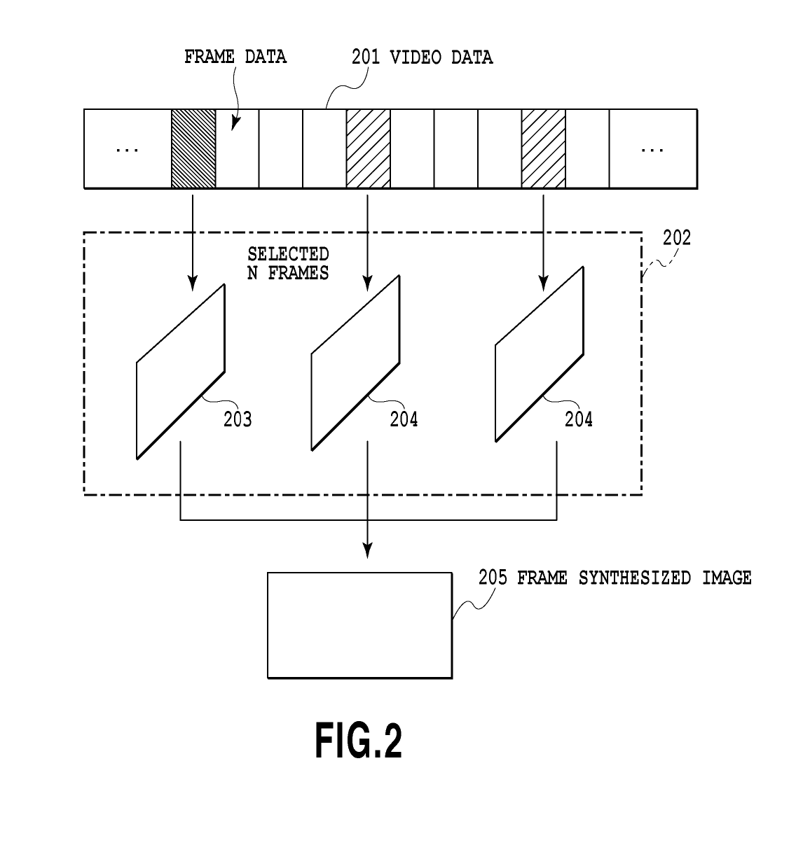

FIG. 2 is a conceptual diagram showing an outline of a method of generating a frame multiplex image according to an embodiment. Video data 201 consists of a plurality of frame images. From the video data 201, a frame group 202 including N (N is an integer not less than two) frames is selected within a specified range, and a multiplex image (frame synthesized image) 205 is generated by estimating a positional relationship between these frame images.

In FIG. 2, it is shown that three (N=3) frames are selected. Hereinafter, a frame 203 specified by a user is described as a reference image and a frame 204 in the neighborhood thereof as a comparison image. As shown in FIG. 2, the comparison image 204 includes not only the frame image nearest to the reference image 203 but also any image near the reference image. An image near the reference image refers to an image located near in the video frame in terms of time.

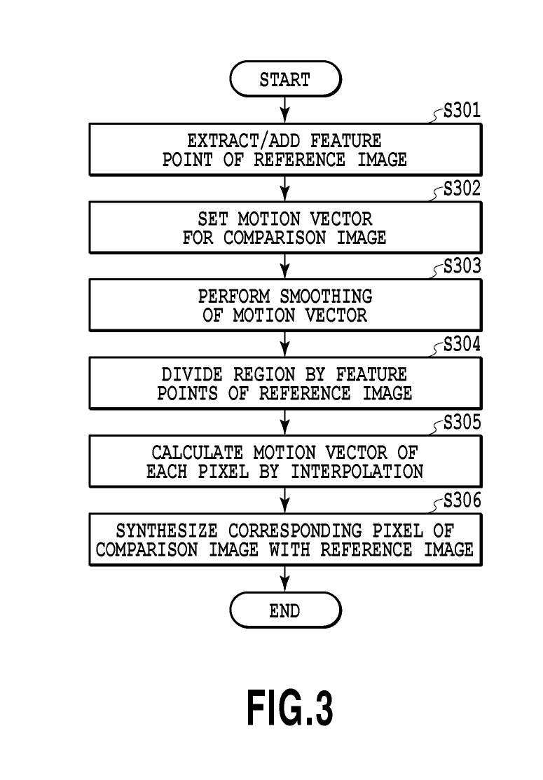

FIG. 3 is a flowchart of frame multiplex image creation process according to an embodiment. In FIG. 3, general processing to create a multiplex image is explained and characteristic processing according to an embodiment will be described later. Prior to the processing in FIG. 3, a reference image is obtained. First, the reference image 203 is analyzed and a feature point of the reference image is extracted (S301). As a feature of the image, one with which a correspondence relationship with a comparison image can be easily identified is extracted as a feature point. For example, a point where edges cross (for example, four corners of a building window) or local singular point is extracted as a feature point. The processing shown in FIG. 3 can be realized by the CPU 101 executing the program stored in the ROM 103.

Next, a region within the comparison image 204 corresponding to each feature point extracted from the reference image 203 in the feature point extraction process in S301 is identified. It is possible to identify a region within the comparison image 204 corresponding to not only the feature point extracted in S301 but also a feature point newly added, as will be described later. Details of a feature point to be added will be described later. As an identification method, it is possible to identify a region corresponding to a feature point by comparing the reference image 203 and the comparison image 204 by using, for example, block matching and the like. At this time, a difference between the coordinate value of a pixel in the reference image 203 extracted as a feature point in the reference image 203 and the coordinate value of a region corresponding to a feature point in the comparison image 204 is set as a motion vector (S302).

There is a case where a region that matches with the feature point in the reference image 203 is not detected in the comparison image 204. That is, in the case of a motion picture, when a camera that has taken an image is moved, the composition itself changes between frames and a subject also moves, and therefore, the feature point extracted from the reference image does not necessarily exist within the comparison image. Consequently, there may be a case where a region that does not originally match with a feature point in the comparison image is detected erroneously as a region corresponding to a feature point when detecting a feature point of the reference image from the comparison image and a motion vector is set based on the detection result. Because of this, it may also be possible to set a degree of reliability to a motion vector itself based on, for example, the comparison result between the reference image and the comparison image. Then, by setting a motion vector of the feature point while reflecting the degree of reliability of one or more motion vector(s) set to its peripheral feature point(s) and thus smoothing of the motion vector is performed (S303).

Next, region division of an image is made by the feature points of the reference image. At this time, the feature point appears at an arbitrary position, and therefore, by setting a plurality of triangular regions consisted of feature points, the image is divided (S304). The division of a region into triangles can be realized by making use of, for example, the method of Delaunay triangulation. In an embodiment, an example is shown in which an image is divided into triangular regions, however, an image may be divided into other polygonal regions, such as quadrangular regions.

In order to perform processing of all the image regions in the reference image, the four corners of the image are added (if not extracted as feature point) as feature points. That is, for example, when one corner has already been extracted as a feature point, feature points are added to the other three corners. A feature point to be added may be added to a position in the neighborhood of the four corners of the image. The four corners of an image and parts in the neighborhood thereof are together referred to as corners. A motion vector corresponding to the added feature point can be identified by a correspondence relationship with the comparison image. That is, a region resembling the added feature point is identified by matching process in the comparison image. However, the added feature point is a region not extracted as a feature point originally, and therefore, there is a case where it is hard to identify the correspondence relationship between images. Because of that, it may also be possible to set a motion vector corresponding to the added feature point by making use of the motion vector of at least one extracted feature point existing in the neighborhood of the added feature point.

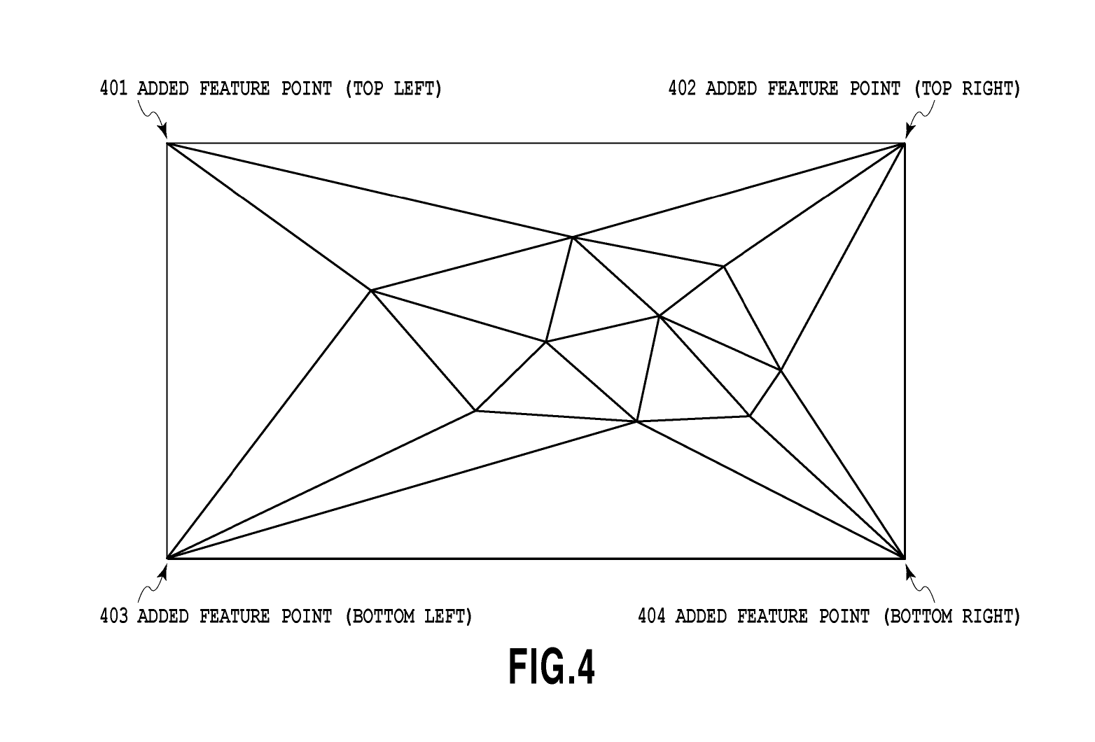

FIG. 4 is an example of region division of a reference image including extracted feature points and added feature points. The vertex of each triangle represents a feature point. It is known that all the pixels constituting the image belong to any of the triangular regions by adding four corners (401, 402, 403 and 404) as feature points as shown schematically. Because all the pixels constituting the image belong to any of the triangular regions, it is possible to estimate (interpolate) a motion vector of an arbitrary pixel and the like within the triangular region for all the pixels constituting the image. The addition of a feature point is explained in relation to S304 for the sake of simplification of the explanation. However, as will be described later, the processing of adding a feature point may also be performed in S301.

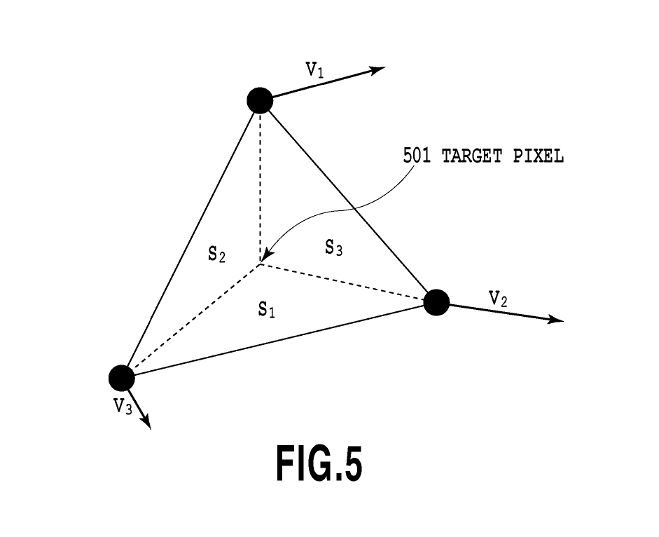

Next, based on the divided triangular regions, a corresponding pixel of the comparison image is determined for each pixel of the reference image. FIG. 5 is a diagram showing a target pixel 501 of the reference image and a triangular region to which the target pixel 501 belongs. The vertexes constituting the triangle to which the target pixel 501 belongs represent feature points and a motion vector is set for each of the feature points.

Consequently, the motion vector of the target pixel 501 is determined by weight-averaging motion vectors (V₁, V₂ and V₃) of the three feature points by three areas (S₁, S₂ and S₃) of the triangles divided by the target pixel (S305). That is, the motion vector element of each feature point is multiplied by the area of the triangle having a side not including itself as a feature point as a weight and the sum of these products is divided by the total of the three areas with which the triangle formed by the feature points is divided. That is, a motion vector V of the target pixel 501 is obtained by the following equation (1).

V=(S₁V₁+S₂V₂+S₃V₃)/(S₁+S₂+S₃) (1)

Finally, the value of pixel of the comparison image, where the pixel is moved by an amount corresponding to the motion vector calculated by interpolation as described above, is synthesized with the target pixel 501 of the reference image at the coordinates thereof (S306). By matching the positional relationship and synthesizing the reference image with the comparison image as described above, it is possible to expect, for example, the effect of noise reduction for a motion picture frame photographed in a dark position.

Next, it is explained about region division of an image according to an embodiment specifically.

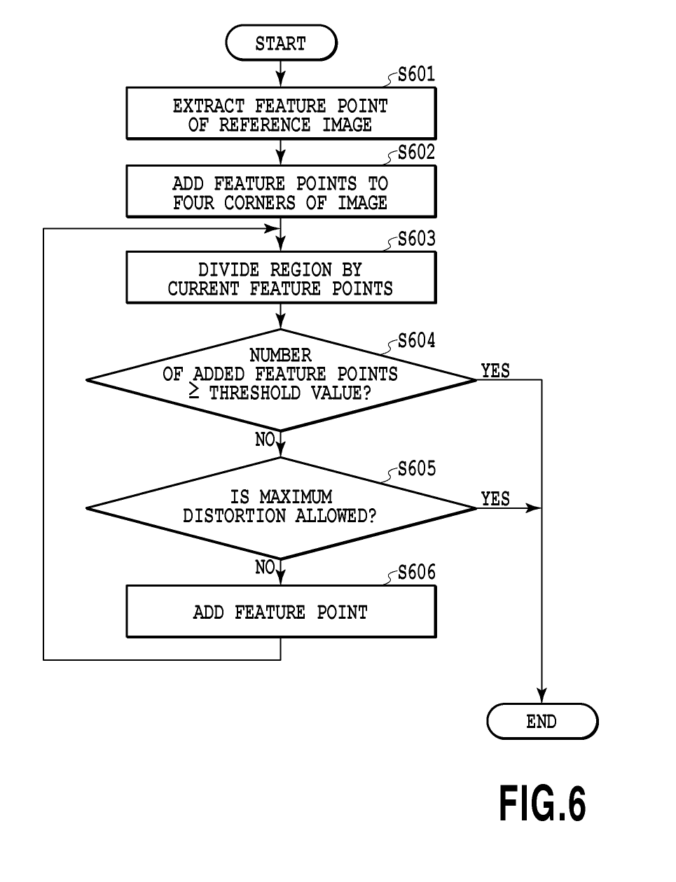

FIG. 6 shows a flowchart in image processing in the first embodiment, explaining S301 in FIG. 3 in more detail. That is, after extracting feature points of the reference image (S601), the four corners of the image are added as feature points (S602).

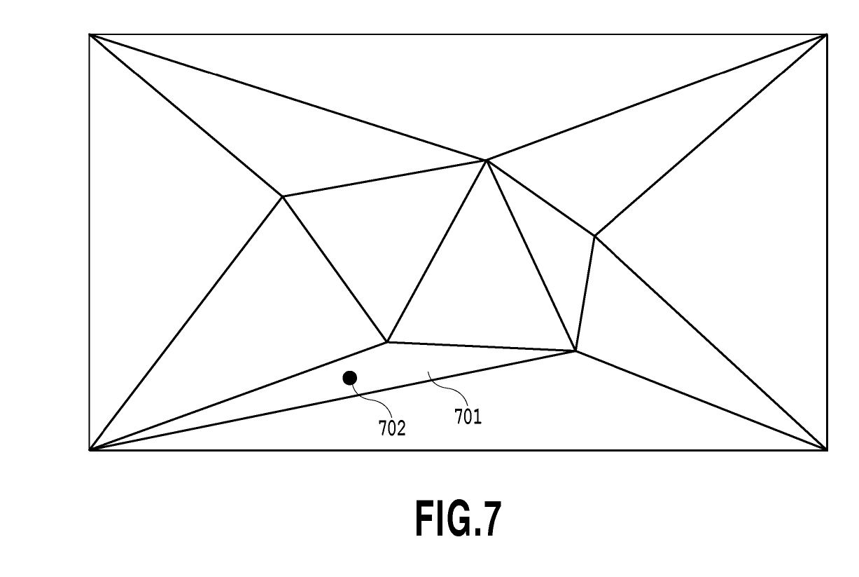

Here, when the number of feature points increases to a certain degree, there is a case where a triangle 701 with a large distortion appears when an image is divided into triangular regions as shown in FIG. 7. When a motion vector is found by area interpolation based on a triangle with a large distortion, the interpolation precision is reduced and at the same time, further, a motion vector is estimated by a far distant feature point as a result. In such a case, it is possible to change the result of region division by, for example, adding a feature point 702 to the inside of the triangle 701 or onto the sides of the triangle 701.

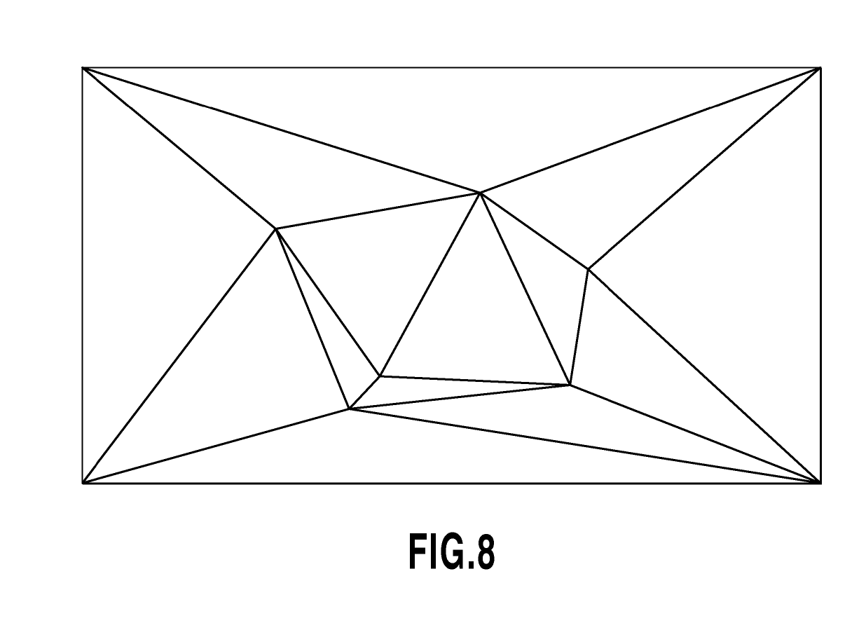

FIG. 8 is a diagram showing the result of the region re-division when the feature point 702 is added in FIG. 7. What is important here is that the triangle with a large distortion is not necessarily divided simply by the feature point added to the inside of the triangle. That is, as can be seen from the comparison between FIG. 7 and FIG. 8, it should be noted that adding one feature point changes not only the shape of the triangle but also the shapes of the triangles in the neighborhood of the triangle.

The Delaunay triangulation method described above includes a method of sequentially analyzing feature points. That is, the re-division of the triangular region requires the analysis of only the added feature point, and therefore, the load in terms of speed is not so heavy. Consequently, in the processing flow, first, the reference image is divided into triangular regions by the feature points extracted in S601 and the current feature points added in S602 (S603). Next, whether the number of added feature points is equal to or less than a predetermined threshold value (for example, 50 points) is checked (S604). This is because feature points to be added are not highly reliable originally and has a disadvantage in the estimation of a motion vector, and therefore, simply increasing the number of feature points does not necessarily result in preferable results. The number of added feature points to be checked in S604 includes the number of feature points added in S602 and the number of feature points added in S606, to be described later.

Next, the individual triangle is analyzed and whether a region having the maximum distortion is below the allowable level is checked (S605). That is, by determining the shape of the individual triangle, whether the distortion of the triangle is a predetermined distortion below the allowable level is checked. It is possible to determine the allowable level in advance by, for example, the side lengths or angles of a triangle. Details will be described later. When the distortion of the triangle satisfies the allowable level, the feature point addition process is exited and the step is proceeded to S302. When the step is proceeded to S302, after the smoothing processing as described above, processing of region re-division and the like is performed in S304 and then a synthesized image is generated in S306. On the other hand, when the distortion of the triangle does not satisfy the allowable level, that is, when the distortion of the triangle is large, a feature point is added to the inside of the triangle (including the sides) or to the periphery thereof.

Here, the position where a feature point is added may be simply the center of gravity of the triangle. Alternatively, it may also be possible to add a pixel having a higher degree of the possibility of being a feature point with priority out of the feature points on the peripheral region as a feature point by holding in advance the degree of the possibility of being a feature point as an amount of evaluation for each pixel when extracting a feature point in S301. The degree of the possibility of being a feature point is determined based on the amount of edge of the image. It should be noted that the addition of a feature point affects not only the inside of the triangle but also a triangle that does not include the added feature point as described above.

Next, the determination of distortion of a triangle is explained in detail.

As described above, interpolation processing of a motion vector is performed by a triangle the region of which is divided by a feature point. In the interpolation processing, when the length of the side of the triangle is long, a motion vector of the target pixel is found based on the motion vector of a feature point far distant from the target pixel as a result, and therefore, there is a case where the reliability of the estimation of the movement of the region is reduced.

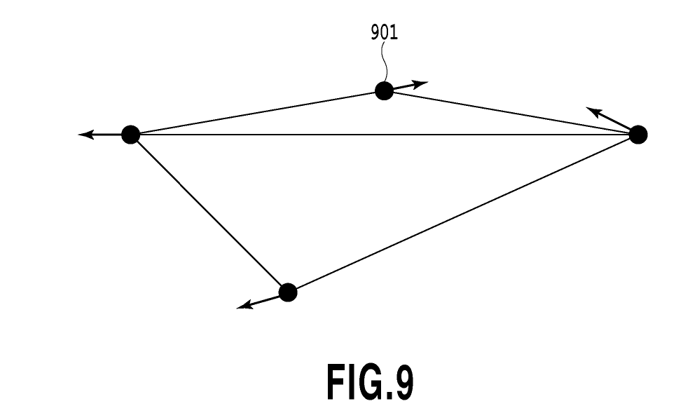

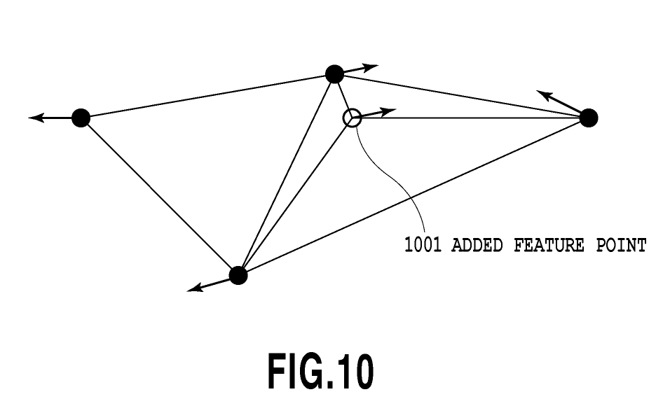

A specific example is explained using FIG. 9. FIG. 9 shows a state where there are four feature points and two triangles having these feature points as vertexes. There can be supposed a case where a feature point 901 has a motion vector different from those of the other feature points as shown in FIG. 9. Particularly, in a motion picture, there is a case where a subject moves in the direction opposite to that of the background (or pan of a camera). In this case, in the lower region of the divided triangles in FIG. 9, all motion vectors are estimated in the fixed direction, however, in actuality, the subject moves in the opposite direction at the center part. That is, there is a case where a motion vector inside thereof cannot be estimated correctly because the vertexes of the triangle are distant from one another. Because of this, a feature point is added to a white circle (1001) in FIG. 10 and the motion vector of the added feature point at 1001 is set to the same motion vector as that of the nearest feature point 901.

By doing so, it is made possible to follow the movement of the subject to a certain degree at the center part of FIG. 10. On the contrary, in the region to which a feature point is to be added in the image, if there is not a feature point extracted from the image in a predetermined range of a feature point to be added, it may also be possible to add no feature point to the region because the reliability of the motion vector of the feature point to be added to the image is reduced. That is, it may also be possible to newly add a feature point to the neighborhood of the feature point extracted from the image.

In an embodiment, when any of the sides of a triangle has a length longer than a predetermined length, the divided region is further divided into smaller regions by adding a feature point. That is, as the criterion of determination of whether the maximum distortion is below the allowable level in S605, the lengths of the sides of the triangle are used. For example, half the height of an image is set as a threshold value and when any of the sides of a triangle is longer than the threshold value, a feature point is added so that the region is divided into smaller regions.

At this time, it may also be possible to add a feature point after identifying a triangle having the longest side or to add a feature point when a triangular region having a side equal to or greater than the threshold value is found. The feature point addition process is exited when all the triangular regions satisfy the above-mentioned conditions or a predetermined number of feature points is added.

Above description shows an example in which the length of a side is evaluated as the determination of distortion of a triangle. Next, another method of evaluating distortion of a shape is shown.

Here, a distortion of a shape of a triangle is evaluated by the angles of the triangle consisted of feature points extracted from an image. Specifically, a vector of each side is formed from the coordinates of each vertex (that is, a feature point) of a triangular region. By forming a vector, it is possible to obtain angles formed by respective sides by making use of the inner product of the vectors and the like.

There is a case where the more acute any of the angles of a triangle, the more the precision of interpolation processing at the time of estimation of a motion vector is reduced. That is, the area when interpolation processing is performed changes abruptly as a result. In particular, when the area interpolation is performed by the integer operation to increase the speed of processing, there occurs a case where the precision cannot be maintained.

Consequently, when the minimum value of the angle formed by each side is equal to or less than a predetermined angle, a feature point is added to the inside of the triangle or to the periphery thereof and then the region is divided again. As a predetermined angle, mention is made, for example, of 5°. The process flows other than that are the same as those of explained relating in FIG. 6.

It may also be possible to use the ratio of the lengths of the three sides of a triangle as an amount of evaluation in determination of distortion of the triangle. For example, the higher the ratio between the “length of the longest side” and the “length of the shortest side”, the larger the distortion of the triangle is. Further, it may also be possible to combine the length of the intermediate side. The ratio between the “length of the longest side” and the “length of the intermediate side” can also be used as an amount of evaluation.

As the conditions of the determination of distortion of a triangle, it may also be possible to combine the length of the side of a triangle with various conditions such as angles of the triangle to determine the distortion of a triangle.

It is needless to say that the amount of evaluation used to determine the distortion of a triangle is not limited to the above and any method can be used as long as the amount of evaluation is one to determine the distortion of a triangle.

Above is a description of a method of increasing the number of feature points by determining the shape of a triangle. Next, a method when the number of feature points is reduced is shown.

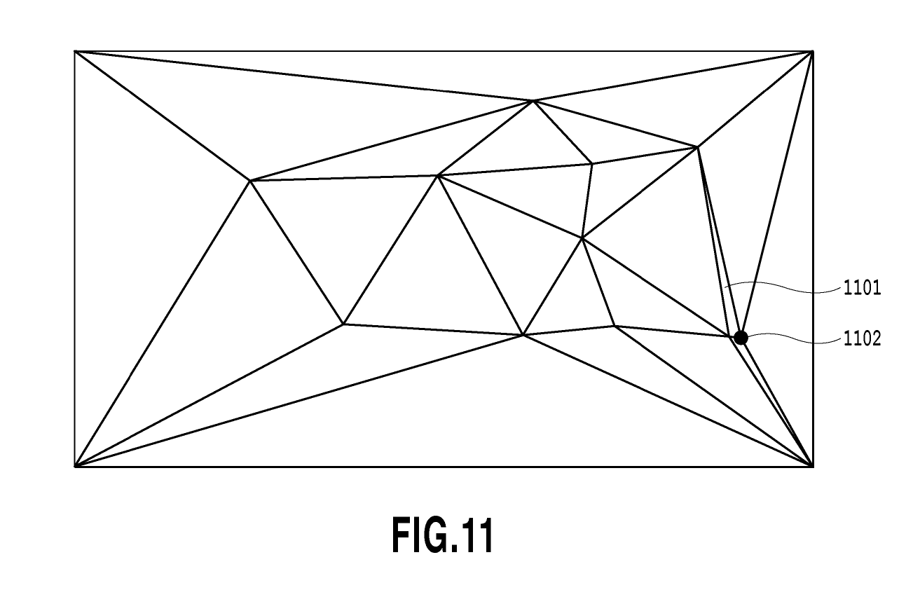

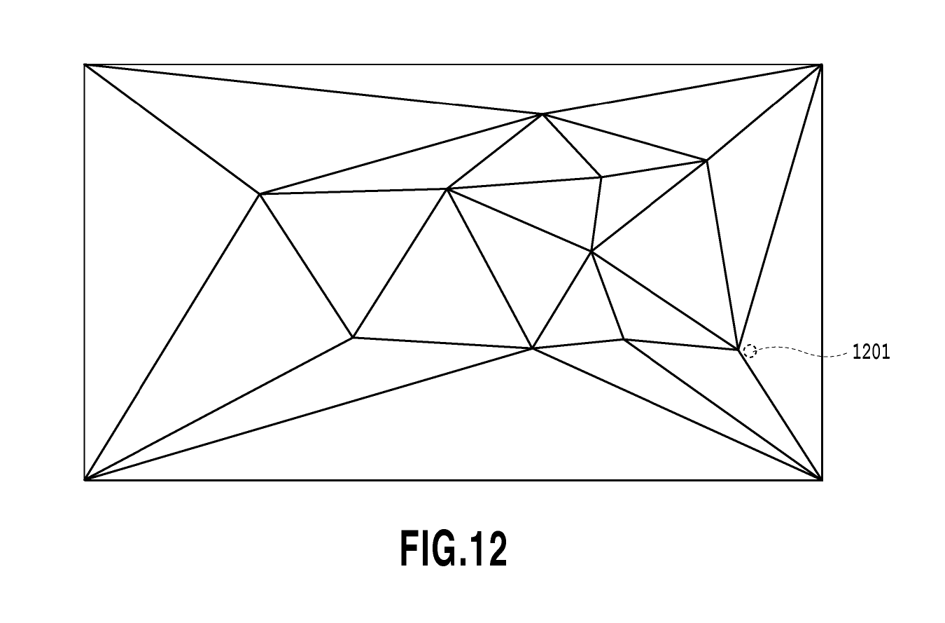

As above explained, the appearance of a triangle with a large distortion is disadvantageous to the estimation precision of a motion vector by area interpolation. Because of this, it may also be possible to delete one of the feature points (for example, a feature point 1102) constituting a triangle 1101 shown in FIG. 11 by determining whether or not there is a distortion based on the determination of the shape of the triangle. The result of the re-division of the region after deleting the feature point 1102 in FIG. 11 is shown in FIG. 12. Reference numeral 1201 in FIG. 12 represents the position of the deleted feature point 1102 shown in FIG. 11. In this manner, it is possible to eliminate a distorted triangle by deleting a feature point constituting the triangle with a large distortion. That is, it is possible to update a feature point used in the region division in S304 by increasing the number of feature points or by deleting a feature point (feature point update process). In S304, it is possible to perform region re-division using the updated feature point.

Here, when deleting a feature point, it may also be possible to delete any of the feature points constituting the shortest side of a triangle or to delete a feature point based on the feature amount of a feature point. It is possible to find the feature amount of a feature point when extracting the feature point in S301 in FIG. 3. For example, when extracting a feature point of an image by determining the edge part of the image, it is possible to take the intensity of the edge (amount of edge) as a feature amount. Then, a feature point with a low feature amount is deleted with priority.

Further, it may also be possible to delete a feature point in the neighborhood of a triangle determined to have a large distortion. This is because, in particular, as the number of feature points increases, the shapes of the triangles become more complicated, and therefore, there is a case where the result of region division changes depending on the change in the surrounding even if a feature point constituting the triangle determined to have a large distortion is not deleted.

According to an embodiment described above, it is possible to determine a motion vector of a feature point with high precision by adding or deleting a feature point according to a position in an image of a feature point extracted from the image and by appropriately dividing the region of the image.

The motion vector calculation method according to an embodiment can be applied to a noise reduction processing method on a computer or an imaging apparatus with a noise reduction function installed therein, such as a digital camera and a digital video camera, and the like.

It is disclosed as the triangulation in the two-dimensional space plane when an image is handled, however, it is also possible to extend the embodiment into the three-dimensional space. For example, color customization can be supposed, in which a plurality of arbitrary colors is corrected into preferred colors in the three-dimensional color space. If an arbitrary color desired to be corrected is deemed as a feature point and an amount of correction is deemed as a motion vector, the space can be divided into a plurality of tetrahedrons by the feature points. In such a case, there is a possibility that a tetrahedron with a large distortion appears as in the case of the two-dimensional triangle and it is needless to say the same problem can be solved by applying the embodiment.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-162294, filed Jul. 16, 2010, which is hereby incorporated by reference herein in its entirety.

What is claimed is:

1. An image processing apparatus comprising:
an obtaining unit configured to obtain a plurality of images;
an extraction unit configured to extract a feature point of an image by analyzing any of the plurality of images obtained by the obtaining unit;
an update unit configured to update the feature point of the image by adding or deleting a feature point to or from the image based on the position in the image of the feature point extracted by the extraction unit; and
a deciding unit configured to decide a motion vector of a pixel included in the image with respect to another image included in the plurality of the images based on the feature point updated by the update unit.

2. The image processing apparatus according to claim 1, comprising:
a setting unit configured to set a region for an image based on the feature point extracted from the image by the extraction unit; and
a determining unit configured to determine a shape of the region of the image set by the setting unit, wherein
the update unit adds or deletes a feature point based on the shape determined by the determining unit.

3. The image processing apparatus according to claim 2, wherein
the determining unit determines a distortion of a polygonal region set by the setting unit.

4. The image processing apparatus according to claim 3, wherein
the determining unit determines the distortion of the polygonal region based on at least one of the length of any side of the polygonal region set by the setting unit, the angle of the polygon, and a ratio between at least two sides constituting the polygon.

5. The image processing apparatus according to claim 3, wherein
the update unit adds a feature point to the inside or onto the side of a polygon determined to have a distortion by the determining unit.

6. The image processing apparatus according to claim 3, wherein
the update unit deletes a feature point constituting a polygon determined to have a distortion by the determining unit.

7. The image processing apparatus according to claim 2, wherein
the deciding unit decides a motion vector of a feature point updated by the update unit and determines a motion vector of a pixel included in a region set by the setting unit in the image based on the motion vector of the feature point.

8. The image processing apparatus according to claim 1, wherein
the extraction unit extracts a feature point based on an amount of edge of an image.

9. The image processing apparatus according to claim 1, wherein
the update unit determines a position of a feature point to be added or deleted in the image based on the amount of edge of the image.

10. An image processing method comprising:
an obtaining step of obtaining a plurality of images;
an extraction step of extracting a feature point of an image by analyzing any of the plurality of images obtained in the obtaining step;
an update step of updating the feature point of the image by adding or deleting a feature point to or from the image based on the position in the image of the feature point extracted in the extraction step; and
a deciding step of deciding a motion vector of a pixel included in the image with respect to another image included in the plurality of the images based on the feature point updated in the update step.

11. A computer-readable recording medium storing program to cause a computer to execute the method according to claim 10.
